(19) United States
(12) Patent Application Publication
(10) Pub. No.: US 2022/0324462 A1
(43) Pub. Date: Oct. 13, 2022

(54) SYSTEM AND METHOD FOR PROVIDING DRIVER BEHAVIOR FEEBACK TO A DRIVER OF A HOST VEHICLE

(71) Applicant: Lear Corporation, Southfield, MI (US)

(72) Inventors: Radovan MIUCIC, Beverly Hills, MI (US); Samer RAJAB, Novi, MI (US)

(73) Assignee: Lear Corporation, Southfield, MI (US)

(21) Appl. No.: 17/301,696

(22) Filed: Apr. 12, 2021

(51) Int. Cl. B60W 40/09; B60W 30/095; B60W 50/14

(52) U.S. Cl. CPC B60W 40/09; B60W 30/0956; B60W 50/14; B60W 30/0953; B60W 2050/146; B60W 2420/52; B60W 2420/54; B60W 2420/42; B60W 2556/45; B60W 2554/80; B60W 2520/10; B60W 2552/00

(57) ABSTRACT

A system for providing driver behavior feedback to driver of a host vehicle in a lane of a roadway may include a sensor to be mounted in the host vehicle for detecting a remote vehicle in front of the host vehicle in the lane and, upon detecting the remote vehicle, generating a remote vehicle detection signal. The system may also include controller to be mounted in the host vehicle, wherein the controller, in response to receipt of the remote vehicle detection signal, is configured to repeatedly determine a time to collision between the host vehicle and the remote vehicle, compare each determined time to collision to a threshold time, and generate a driver feedback signal for use in providing an indication to the host vehicle driver of a measure of host vehicle driver behavior based on a number of times the determined time to collision exceeds the threshold time.

### TECHNICAL FIELD

The following relates to a system and method for providing driver behavior feedback to a driver of a host vehicle.

### BACKGROUND

Safe driving of motor vehicles is highly regarded and desired among the public, by governmental authorities, and in the automotive industry to reduce fatalities, injuries, and property damage. In the automotive industry, systems to assist driver operation of a vehicle, provide information to a driver, and/or enhance or improve driving safety are well known. Such systems include, for example, automated driver assistance systems (ADAS), telematics control units (TCU), vehicle-to-anything (V2X) communication systems, and other safety related applications.

While such systems have improved driving safety, additional systems to further enhance driving safety are still desired. As a result, there exists a need for a system and method that would further enhance or improve driving safety by providing driver behavior feedback to a driver of a host vehicle concerning the driving behavior of the host vehicle driver as such behavior relates to driving safety.

Such a system and method for providing driver behavior feedback to a host vehicle driver would improve or enhance driving safety by providing or enabling the provision of an indication, status, or measure to the host vehicle driver concerning the following distance or time that the host vehicle driver maintains for the host vehicle when traveling behind a remote vehicle in front of and traveling in the same lane as the host vehicle. Such a system and method providing such an indication, status, or measure of driver behavior would assist the host vehicle driver to determine and/or maintain a predetermined following distance or time that reduces the risk of a collision between the host vehicle and the preceding remote vehicle. Such a system and method could also improve driving habits of a host vehicle driver by linking or tying the maintenance of such a predetermined following distance or time to benefits, advantages, privileges, or rewards for the host vehicle driver.

### SUMMARY

According to one non-limiting exemplary embodiment described herein, a system for providing driver behavior feedback to a driver of a host vehicle traveling in a lane of a roadway is provided. The system may comprise a sensor to be mounted in the host vehicle for detecting a presence of a remote vehicle in front of the host vehicle in the lane of the roadway and, upon detecting the remote vehicle, generating a remote vehicle detection signal. The system may further comprise a controller to be mounted in the host vehicle and provided in communication with the sensor, wherein the controller, in response to receipt of the remote vehicle detection signal from the sensor, is configured to repeatedly determine a time to collision between the host vehicle and the remote vehicle, compare each determined time to collision to a threshold time, and generate a driver feedback signal for use in providing an indication to the host vehicle driver of a measure of host vehicle driver behavior based on a number of times the determined time to collision exceeds the threshold time.

According to another non-limiting exemplary embodiment described herein, a method for providing driver behavior feedback to a driver of a host vehicle traveling in a lane of a roadway is provided. The method may comprise repeatedly determining a time to collision between the host vehicle and the remote vehicle, comparing each determined time to collision to a threshold time, and generating a driver feedback signal for use in providing an indication to the host vehicle driver of a measure of host vehicle driver behavior based on a number of times the determined time to collision exceeds the threshold time.

According to yet another non-limiting exemplary embodiment described herein, a non-transitory computer readable storage medium is provided having stored computer executable instructions for providing driver behavior feedback to a driver of a host vehicle traveling in a lane of a roadway, the host vehicle comprising a sensor for detecting a presence of a remote vehicle in front of the host vehicle in the lane of the roadway and, upon detecting the remote vehicle, generating a remote vehicle detection signal, and a controller configured to receive the remote vehicle detection signal from the sensor. The computer executable instructions may be configured to cause the controller to repeatedly determine a time to collision between the host vehicle and the detected remote vehicle, compare each determined time to collision to a threshold time, and generate a driver feedback signal for use in providing an indication to the host vehicle driver of a measure of host vehicle driver behavior based on a number of times the determined time to collision exceeds the threshold time.

A detailed description of these and other non-limiting exemplary embodiments of a system and method for providing driver behavior feedback to a driver of a host vehicle is set forth below together with the accompanying drawings.

### BRIEF DESCRIPTION OF THE DRAWINGS

FIGS. 1A and 1B are exemplary block diagrams of a host vehicle and remote vehicle according to one non-limiting exemplary embodiment of the present disclosure;

FIG. 2 is a table illustrating exemplary icons for use in providing an indication, status, or measure of host vehicle driver behavior according to one non-limiting exemplary embodiment of the present disclosure;

FIGS. 3A-3D are diagrams of exemplary human-machine interfaces for use with one non-limiting exemplary embodiment of the present disclosure; and

FIGS. 4A-4C are flowcharts of exemplary algorithms according to one non-limiting exemplary embodiment of the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components, elements, features, items, members, parts, portions, or the like. Therefore, specific structural and functional details disclosed herein are not to be interpreted as limiting, but merely as a representative basis for teaching one skilled in the art.

With reference to the Figures, a more detailed description of non-limiting exemplary embodiments of a system and method for providing driver behavior feedback to a driver of a host vehicle will be provided. For ease of illustration and to facilitate understanding, like reference numerals may be used herein for like components and features throughout the drawings.

As previously described, safe driving of motor vehicles is highly regarded and desired among the public, by governmental authorities, and in the automotive industry to reduce fatalities, injuries, and property damage. In the automotive industry, systems to assist driver operation of a vehicle, provide information to a driver, and/or enhance or improve driving safety are well known. Such systems include, for example, automated driver assistance systems (ADAS), telematics control units (TCU), vehicle-to-anything (V2X) communication systems, and other safety related applications.

Nevertheless, as also previously described, there exists a need for a system and method that would further enhance or improve driving safety by providing driver behavior feedback to a driver of a host vehicle concerning the driving behavior of the host vehicle driver as such behavior relates to driving safety. Such a system and method for providing feedback to a host vehicle driver would improve or enhance driving safety by providing or enabling the provision of an indication, status, or measure to the host vehicle driver concerning the following distance or time that the host vehicle driver maintains for the host vehicle when traveling behind a remote vehicle in front of and traveling in the same lane as the host vehicle. Such a system and method providing such an indication, status, or measure of driver behavior would assist the host vehicle driver to determine and/or maintain a predetermined following distance or time that reduces the risk of a collision between the host vehicle and the preceding remote vehicle. Such a system and method could also improve driving habits of a host vehicle driver by linking or tying the maintenance of such a predetermined following distance or time to benefits, advantages, privileges, or rewords for the host vehicle driver.

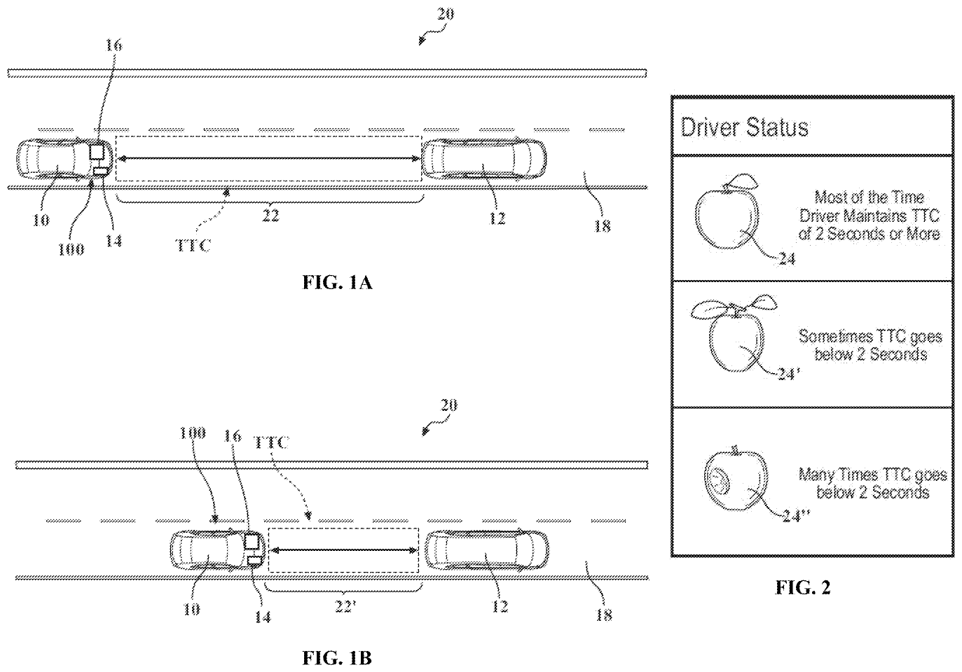

In that regard, FIGS. 1A and 1B are exemplary block diagrams of a host vehicle (HV) 10 and remote vehicle (RV) 12 according to one non-limiting exemplary embodiment of the present disclosure. As seen therein, the HV 10 may be provided or equipped with a sensor 14 and a controller 16, which may be provided in communication with the sensor 14. As also seen therein, the HV 10 may travel in a lane 18 of a roadway 20. Similarly, the RV 12 may be located in front of and travel in the same lane 18 as the HV 10.

FIG. 1A illustrates a first time-to-collision (TTC) 22 between the HV 10 and the RV 12, while FIG. 1B illustrates a second TTC 22′ between the HV 10 and the RV 12. As depicted in FIGS. 1A and 1B, the first TTC 22′ represents a following time for the HV 10 relative to the RV 12 greater than a predetermined threshold time that is likely to provide adequate or sufficient reaction time for the driver of the HV 10 to react and/or take action to sufficiently reduce a speed of the HV 10 to eliminate or reduce the risk of a collision between the HV 10 and RV 12 in the event the driver of the RV 12 reduces a speed of the RV 12. In that regard the TTC 22, 22′ illustrated are exemplary only and the determination thereof is described in further detail herein.

FIGS. 1A and 1B therefore illustrate one non-limiting exemplary embodiment of a system 100 for providing feedback to a driver of a HV 10 traveling in a lane 18 of a roadway 20. The system 100 may comprise a sensor 14 to be mounted in the HV 10 for detecting a presence of a RV 12 in front of the HV 10 in the lane 18 of the roadway 20 and, upon detecting the remote vehicle, generating a remote vehicle detection signal. In that regard, the sensor 14 may comprise a radar, lidar, ultrasonic, camera, vehicle-to-x (i.e., vehicle-to-anything), or any other type of sensor, unit, device, or system known to those of ordinary skill for performing such functions.

The system 100 may further comprise a controller 16 to be mounted in the HV 10 and provided in communication with the sensor 14. The controller 16, in response to receipt of the remote vehicle detection signal from the sensor 14, may be configured to repeatedly determine a TTC 22, 22′ between the HV 10 and the RV 12, compare each determined TTC 22, 22′ to a threshold time, and generate a driver behavior feedback signal for use in providing to the HV driver an indication, status, or measure of HV driver behavior based on a number of times the determined TTC 22, 22′ exceeds the threshold time.

Thus, the present disclosure provides a sensor-based application or “game” that may influence safer driving, which application or “game” may be referred to as “Tailgate Me Not” (“TMN”). In general, the sensor 14 of the HV 10 may detect a first RV 12 in front of and in the same lane 18 of the HV 10 and the controller 16 of the HV 10 computes a distance and TTC 22, 22′ between the HV 10 and the RV 12. Based on the TTC 22, 22′ over a period of time, the controller 16 may assess a driver status, level, indication or measure of driver behavior of the driver of the HV 10 and provide an indication of such an assessment, status, level, indication, or measure to the driver of the HV 10.

For example, a driver status or level of “good” may be provided or indicated to the driver of the HV 10 when the driver of the HV 10 maintains a TTC 22, 22′ of two seconds or more on most or all occasions, or most or all of the time. Furthermore, a driver status or level of “could be better” may be provided or indicated to the driver of the HV 10 when the driver of the HV 10 maintains a TTC 22, 22′ of less than two seconds on some occasions or sometimes. Still further, a driver status or level of “needs improvement” may be provided or indicated to the driver of the HV 10 when the driver of the HV 10 maintains a TTC 22, 22′ of less than two seconds on many occasions or many times.

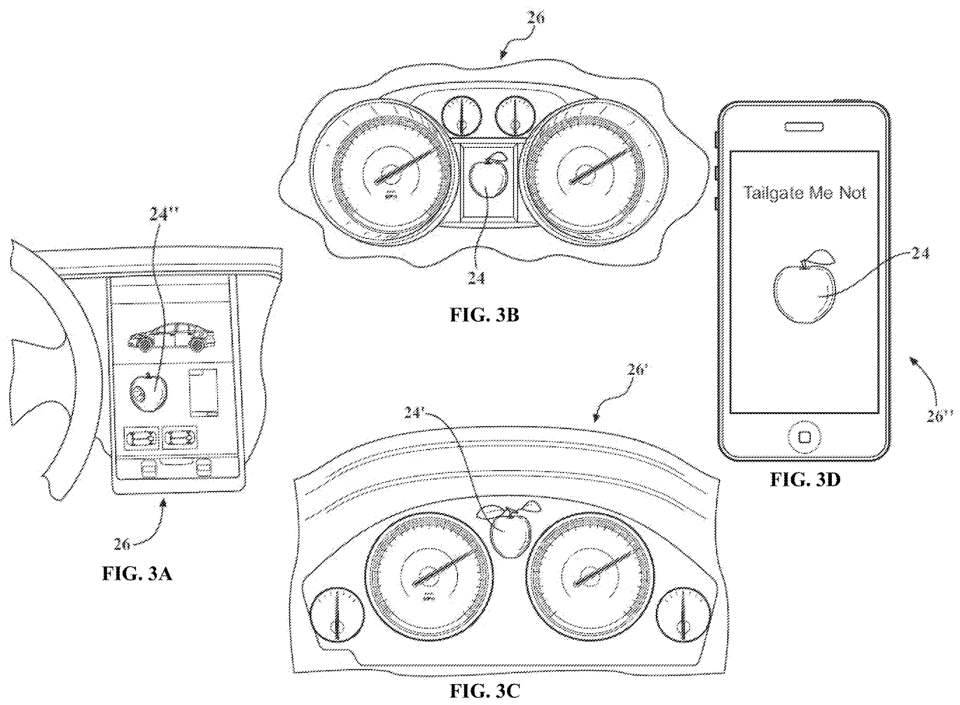

In that regard, FIG. 2 is a table illustrating exemplary icons for use in providing an indication, status, level, or measure of host vehicle driver behavior according to one non-limiting exemplary embodiment of the present disclosure. As seen therein, the “good” driver status level described herein may be indicated to the driver of the HV 10 by the display to the driver of a green apple icon 24. Similarly, the “could be better” driver status level described herein may be indicated to the driver of the HV 10 by the display to the driver of a yellow apple icon 24′. Finally, the “needs improvement” driver status level described herein may be indicated to the driver of the HV 10 by the display to the driver of a saggy or bruised brown-red apple icon 24″. Alternatively, the apple icons 24, 24′, 24″, which are exemplary only, could be replaced with any other type of icons that would intuitively provide such driver behavior status information (i.e., “good”, “could be better”, “needs improvement”) to the driver of the HV 10.

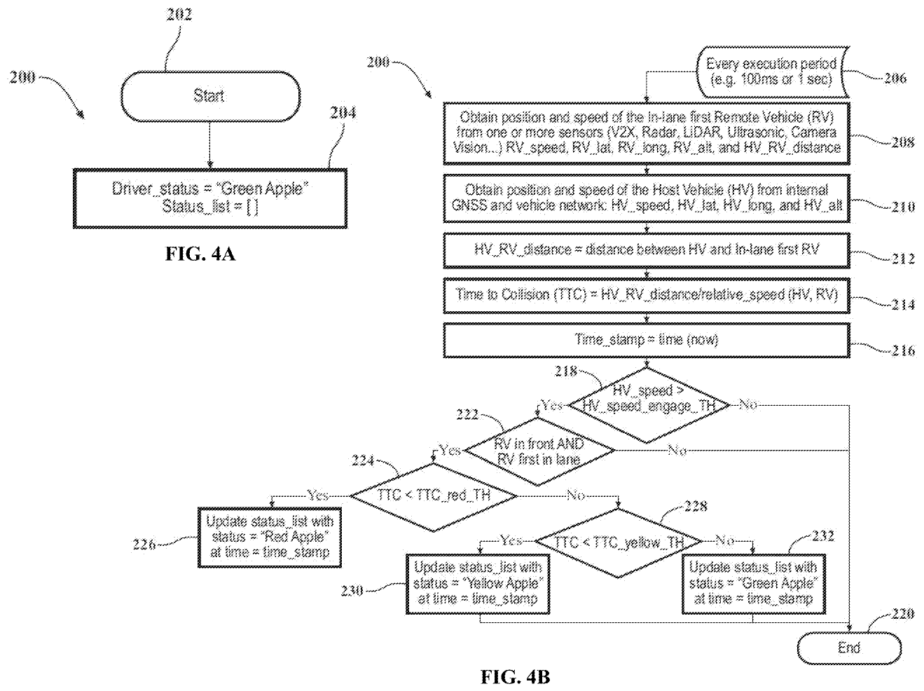

In that same regard, FIGS. 3A-3D are diagrams of exemplary human-machine interfaces for use with one non-limiting exemplary embodiment of the present disclosure. As seen therein, the system 100 of the present disclosure may further comprise a human-machine interface (HMI) for use in providing the driver behavior status or level indications to the driver of the HV 10. More specifically, the HMI may comprise an in-vehicle central console display unit 26 (see FIGS. 3A, 3B) or a dashboard display unit 26′ (see FIG. 3C) which may be provided in wired communication with the controller 16 of the HV 10 and configured to receive the previously described driver behavior feedback signal generated by the controller 16 of the HV 10 and to display any of the icons 24, 24′, 24″ to the driver of the HV 10. Alternatively, the HMI may comprise a personal or remote device, such as a mobile phone, having a display unit 26′ (see Figured 3D) which may be provided in communication with the controller 16 of the HV 10 (e.g., via a Universal Serial Bus (USB) or any other type of wired connection, or via a Bluetooth or any other type of wireless connection) and configured to receive the previously described driver behavior feedback signal generated by the controller 16 of the HV 10 and to display any of the icons 24, 24′, 24″ to the driver of the HV 10.

It should be noted that the threshold or thresholds for the number of times that the driver of the HV 10 maintains the TTC 22, 22′ of the HV 10 to the RV 12 above or below two seconds in order to achieve any of the driver behavior status levels of “good”, “could be better”, or “needs improvement” may be any number or numbers of times and may be pre-set, pre-selected, pre-determined, configured, configurable, adjusted, and/or adjustable, as desired. It should also be noted that the threshold time described herein of two seconds for the TTC 22, 22′ is exemplary only and any other amount of time may be utilized. Moreover, the threshold time described herein for the TTC 22, 22′ may also be pre-set, pre-selected, pre-determined, configured, configurable, adjusted, and/or adjustable, as desired. For example, the threshold time may be adjusted or configured to account for inclement weather and/or size and/or weight of the host vehicle.

Referring again to FIGS. 1A and 1B, according to the system 100 of the present disclosure, as previously described, the controller 16 of the HV 10 may be further configured to determine a distance between the HV 10 and the RV 12, to receive a signal indicative of a speed of the HV 10, and to determine the TTC 22, 22′ based on at least the determined distance and the speed of the HV 10. In that regard, the controller 16 of the host vehicle may be further configured to receive a signal indicative of the speed of the RV 12, determine a speed of the HV 10 relative to the RV 12 (i.e., a difference between the speed of the HV 10 and the speed of the RV 12, or a speed differential between the HV 10 and the RV 12), and determine the TTC 22, 22′ based on the determined distance and the relative speed of the HV 10 to the RV 12.

With reference now to FIGS. 1A-3D, according to the system 100 of the present disclosure, the status, level, indication, or measure of host driver behavior may comprise a first value 24 when the number of times that the determined TTC 22, 22′ exceeds the threshold time exceeds a first threshold value. Furthermore, the status, level, indication, or measure of host driver behavior may comprise a second value 24′ less than the first value 24 when the number of times the determined TTC 22, 22′ exceeds the threshold time fails to exceed the first threshold value. Still further, the status, level, indication, or measure of host driver behavior may comprise a third value 24″ less than the second value 24′ when the number of times that the determined TTC 22, 22′ exceeds the threshold time fails to exceed a second threshold value less than the first threshold value.

The system 100 of the present disclosure may further comprise a memory or storage device or unit, such as a memory associated with the controller 16 of the HV 10, for storing a value of the status, level, indication, or measure of the host vehicle driver behavior. In that regard, according to the system 100 of the present disclosure, the driver of the HV 10 may earns a privilege when the measure of host vehicle driver behavior comprises the first value 24. That is, the stored driver status of the application or “game” TMN may be linked or communicated to another party and used by such a party to provide privileges, benefits, and/or advantages to the driver of the HV 10. For example, the stored driver status level may be linked or communicated to insurance companies and the driver of the HV 10 may receive a discount for maintaining a green apple icon 24 status. Alternatively, or in addition, such a driver status 24 may linked or provided to a governmental agency to provide the driver of the HV 10 with High-Occupancy Vehicle (HOV) lane privileges that might otherwise not be available based on the number of occupants in the HV 10. As well, such a driver status 24 may alternative or in addition be linked or communicated to a developer to provide the driver of the HV 10 with a “favorite car” status and/or icon in a navigation application, or with boosting ratings/credentials to rideshare drivers. In that regard, the controller 16 of the HV 10 may include or be provided in communication with an in-vehicle cellular communication unit or a remote or personal cellular communication unit (see, e.g., FIG. 3D) to transmit such a driver status 24 to another party or parties.

As those skilled in the art will understand, the sensor 14, controller 16, display unit 26, 26′, 26″, communication unit of the HV 10, as well as any other controller, unit, component, module, system, subsystem, interface, sensor, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC), Electronic Control Unit (ECU), or Telematics Control Unit (TCU), or several processors and various circuitry and/or hardware may be distributed among several separate components, whether individually packaged or assembled into a System-on-a-Chip (SoC). The sensor 14, controller 16, display unit 26, 26′, 26″, and communication unit of the HV 10 may therefore each or in any combination comprise a processor and an associated storage medium, unit, or device having stored computer executable instructions for performing the particular algorithm or algorithms represented by the various methods, functions and/or operations described herein.

Still referring to FIGS. 1A-3D, the present disclosure also provides a non-limiting exemplary embodiment of a method for providing driver behavior feedback to a driver of a HV traveling in a lane 18 of a roadway 20. In that regard, the method may comprise repeatedly determining a TTC 22, 22′ between the HV 10 and an RV 12, comparing each determined TTC 22, 22′ to a threshold time, and generating a driver behavior feedback signal for use in providing an indication to the driver of the HV 10 of a measure of host vehicle driver behavior based on a number of times the determined TTC 22, 22′ exceeds the threshold time.

The method may further comprise detecting a presence of the RV 12 in front of the HV 10 in the lane 18 of the roadway 20, as well as determining a distance between the HV 10 and the RV 12. Moreover, determining the TTC 22, 22′ may be based on at least the determined distance and a speed of the HV 10. In that regard, the method may further comprise receiving or determining a speed of the HV 10, receiving or determining speed of the RV 12, and/or a determining a speed of the HV 10 relative to the RV 12 (i.e., a difference between the speed of the HV 10 and the speed of the RV 12, or a speed differential between the HV 10 and the RV 12), and determining the TTC 22, 22′ based on the determined distance and the relative speed of the HV 10 to the RV 12.

According to this non-limiting exemplary method of the present disclosure the measure of host driver behavior may comprise a first value 24 when the number of times the determined TTC 22, 22′ exceeds the threshold time exceeds a first threshold value. Furthermore, the measure of host driver behavior may comprise a second value 24′ less than the first value 24 when the number of times the determined TTC 22, 22′ exceeds the threshold time fails to exceed the first threshold value. Still further, the measure of host driver behavior may comprise a third value 24″ less than the second value 24′ when the number of times that the determined TTC 22, 22′ exceeds the threshold time fails to exceed a second threshold value less than the first threshold value.

The method may further comprise storing a value of the measure of the host vehicle driver behavior in a memory. In that regard, according to the method of present disclosure, the driver of the HV 10 may earn a privilege when the measure of host vehicle driver behavior comprises the first value 24. That is, the stored driver status of the application or “game” TMN may be linked or communicated to another party and used by such a party to provide privileges, benefits, and/or advantages to the driver of the HV 10, as previously described.

Referring still to FIGS. 1A-3D, the present disclosure also provides a non-limiting exemplary embodiment of a non-transitory computer readable storage medium having stored computer executable instructions for providing driver behavior feedback to a driver of a HV 10 traveling in a lane 18 of a roadway 20, the HV 10 comprising sensor 14 for detecting a presence of a RV 12 in front of the HV 10 in the lane 18 of the roadway 20 and, upon detecting the RV 12, generating a remote vehicle detection signal, and a controller 16 configured to receive the remote vehicle detection signal from the sensor 14. The computer executable instructions may be configured to cause the controller 16 to repeatedly determine a TTC 22, 22′ between the HV 10 and the detected RV 12, compare each determined TTC 22, 22′ to a threshold time, and generate a driver behavior feedback signal for use in providing an indication to the driver of the HV 10 of a measure of host vehicle driver behavior based on a number of times the determined TTC 22, 22′ exceeds the threshold time.

The computer executable instructions may be further configured to cause the controller 16 to determine a distance between the HV 10 and the RV 12, and determine the TTC 22, 22′ based on at least the determined distance and a speed of the HV 10. In that regard, the computer executable instructions may be further configured to cause the controller 16 to receive or determine a speed of the HV 10, receive or determine a speed of the RV 12, and/or determine a speed of the HV 10 relative to the RV 12 (i.e., a difference between the speed of the HV 10 and the speed of the RV 12, or a speed differential between the HV 10 and the RV 12), and determine the TTC 22, 22′ based on the determined distance and the relative speed of the HV 10 to the RV 12.

Once again, the measure of host driver behavior may comprise a first value 24 when the number of times the determined TTC 22, 22′ exceeds the threshold time exceeds a first threshold value, and the measure of host driver behavior may comprise a second value 24′ less than the first value 24 when the number of times the determined TTC 22, 22′ exceeds the threshold time fails to exceed the first threshold value. The measure of host driver behavior may further comprise a third value 24″ less than the second value 24′ when the number of times that the determined TTC 22, 22′ exceeds the threshold time fails to exceed a second threshold value less than the first threshold value.

The computer executable instructions may be further configured to cause the controller 16 to store a value of the measure of the host vehicle driver behavior in a memory. In that regard, according to the non-transitory computer readable storage medium of the present disclosure, the driver of the HV 10 may earn a privilege when the measure of host vehicle driver behavior comprises the first value 24. That is, the computer executable instructions may be further configured to cause the controller 16 to link or communicate the stored driver status of the application or “game” TMN to another party for use by such a party to provide privileges, benefits, and/or advantages to the driver of the HV 10, as previously described.

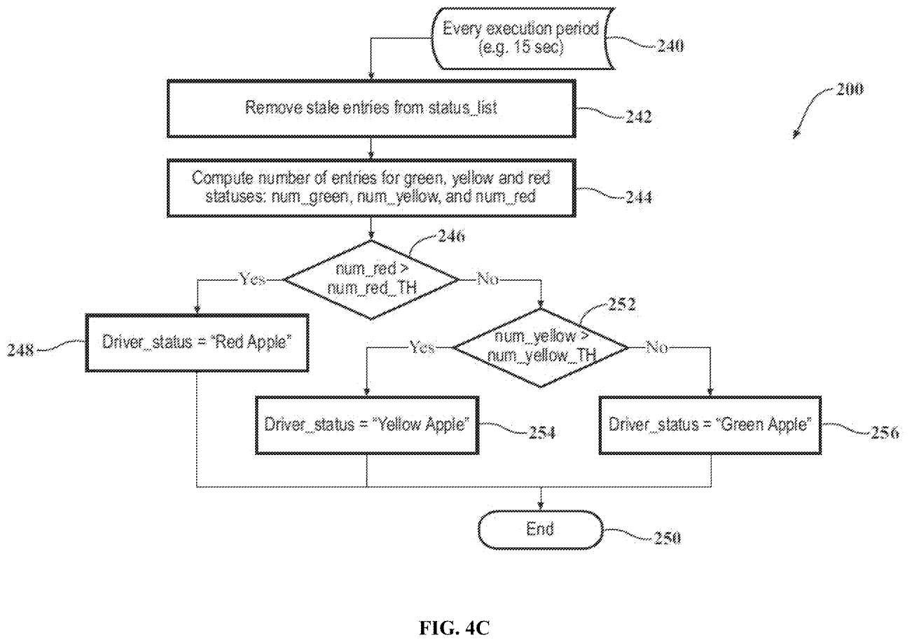

Referring now to FIGS. 4A-4C, flowcharts are illustrated of an exemplary algorithm(s) 200 according to one non-limiting exemplary embodiment of the present disclosure. In general, the “Tailgate Me Not” (TMN) application may be executed in the controller 16, which may take the form of an ECU or TCU as previously described (henceforward referred to as ECU). As seen in FIG. 4A, and with continuing reference to FIGS. 1A-3D, at initialization or start 202, the driver of the HV 10 may be initially awarded “green apple” status 24. That is, at initialization 202, the driver status is set 204 to “green apple” 24. On every trip, a driving status for the driver of the HV 10 is assessed with respect to tailgating. A daily history of driver status may be stored in permanent memory of the ECU. Moreover, an average of the driver status computed over a rolling time window (which may be a configurable time) may be displayed to the driver of the HV 10 (see FIGS. 2, 3A-3D). For example, such a time window may be from a current time to 45 minutes in the past. It should be noted, however, that any other time window may be utilized, and that such a time window may be pre-set, pre-selected, pre-determined, configured, configurable, adjusted, and/or adjustable, as desired.

As seen in FIG. 4B, and with continuing reference to FIGS. 1A-3D, according to one non-limiting exemplary algorithm(s) 200, a driver status may be periodically updated 206 at every execution period (e.g., every 100 milliseconds or every 1 second). In that regard, a position (RV_latitude, RV_longitude, RV_altitude) and speed (RV_speed) of the RV 12 may be obtained 208 via sensor 14 of HV 10. As well, a position (HV_latitude, HV_longitude, HV_altitude) and speed (HV_speed) of the HV 10 may be obtained 210, such as via a global navigation satellite system (GNSS) and/or a HV network.

Thereafter, a distance between the HV 10 and the RV 12 (HV RV distance) may be determined 212, where such difference may be based on the positions of the HV 10 and the RV 12. A relative speed between the HV 10 and the RV 12 (relative speed (HV, RV) may also be determined based on the obtained speeds of the HV 12 and the RV 12. A TTC 22, 22′ may also be determined 214 by dividing the distance between the HV 10 and the RV 12 by the relative speed between the HV 10 and the RV 12. A time stamp 216 may also be attached or associated with the determined TTC 22, 22′.

Referring still to FIG. 4B, and with continuing reference to FIGS. 1A-3D, the speed of the HV 10 may be compared 218 to a speed threshold. If the speed of the HV 10 fails to exceed the speed threshold, the algorithm 200 ends 220. Alternatively, if the speed of the HV 10 exceeds the speed threshold, the algorithm 200 may determine 222 whether the RV 12 is in front of and in the same lane 18 as the HV 10. If not, the algorithm 200 ends 220. Alternatively, if the RV 12 is in front of and in the same lane as the HV 10, the algorithm 200 may determine 224 whether the previously determined TTC 22, 22′ is less than a first threshold time (e.g., one second). If so, the driver status level for the driver of the HV 10 may be updated 226 to “red apple” status 24″ at the time represented by the time stamp associated with the TTC 22, 22′.

Alternatively, if the previously determined TTC 22, 22′ is greater than the first threshold time (e.g., one second), the algorithm 200 may determine 228 whether the TTC 22, 22′ is less than a second threshold time (e.g., two seconds) greater than the first threshold. If so, the driver status level for the driver of the HV 10 may be updated 230 to “yellow apple” status 24′ at the time represented by the time stamp associated with the TTC 22, 22′. Alternatively, if the TTC 22, 22′ is greater than the second threshold time (e.g., two seconds), the driver status level for the driver of the HV 10 may be updated 232 to “green apple” status 24 at the time represented by the time stamp associated with the TTC 22, 22′. Here again, the first and second threshold times may be any time period(s) and may be pre-set, pre-selected, pre-determined, configured, configurable, adjusted, and/or adjustable, as desired.

As seen in FIG. 4C, and with continuing reference to FIGS. 1A-3D, according to one non-limiting exemplary algorithm(s) 200, an HMI or display of the driver status may be periodically updated 240 at every execution period (e.g., every 15 seconds or every 1 minute). In that regard, stale entries from a stored driver status list (e.g., entries older than 45 minutes in the past) may be removed 242 from the stored driver status list. Thereafter, the algorithm 200 may compute 244 the number of “green” status entries, “yellow” status entries, and “red” status entries in the driver status list for a rolling window of time (which may be configurable), where such status entries may be determined as previously described (see, e.g., FIG. 4B).

The algorithm 200 may then compare 246 the number or “red” statuses computed to a first or “red number” threshold. If the number of “red” statuses exceeds the first threshold, the driver status may be set 248 to “red apple” and a “red apple” status icon 24″ may be displayed to the driver of the HV 10 (see FIGS. 2, 3A-3D). Alternatively, if the number of “red” statuses fails to exceed the first threshold, the algorithm 200 may then compare 252 the number or “yellow” statuses computed to a second or “yellow number” threshold. If the number of “yellow” statuses exceeds the second threshold, the driver status may be set 254 to “yellow apple”, and a “yellow apple” status icon 24′ may be displayed to the driver of the HV 10 (see FIGS. 2, 3A-3D). Alternatively, if the number of “yellow” statuses fails to exceed the second threshold, the driver status may be set 254 to “green apple”, and a “green apple” status icon 24 may be displayed to the driver of the HV 10 (see FIGS. 2, 3A-3D). After a driver status is set 248, 254, 256 and the corresponding status icon 24″, 24′, 24 is displayed to the driver of the HV 10, the algorithm 200 may end 250.

The present disclosure thus describes various non-limiting embodiments of a system and method for providing driver behavior feedback to a driver of a host vehicle. In that regard, the present disclosure describes a system and method for providing feedback to a host vehicle driver that may improve or enhance driving safety by providing or enabling the provision of an indication, status, or measure to the host vehicle driver concerning the following distance or time that the host vehicle driver maintains for the host vehicle when traveling behind a remote vehicle in front of and traveling in the same lane as the host vehicle. By providing such an indication, status, or measure of driver behavior, the system and method of the present disclosure may assist the host vehicle driver to determine and/or maintain a predetermined following distance or time that reduces the risk of a collision between the host vehicle and the preceding remote vehicle. The system and method of the present disclosure may also improve driving habits of a host vehicle driver by linking or tying the maintenance of such a predetermined following distance or time to benefits, advantages, privileges, or rewords for the host vehicle driver.

As is readily apparent from the foregoing, various non-limiting embodiments of a system and method for providing driver behavior feedback to a driver of a host vehicle have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A system for providing driver behavior feedback to a driver of a host vehicle traveling in a lane of a roadway, the system comprising:
a sensor to be mounted in the host vehicle for detecting a presence of a remote vehicle in front of the host vehicle in the lane of the roadway and, upon detecting the remote vehicle, generating a remote vehicle detection signal; and
a controller to be mounted in the host vehicle and provided in communication with the sensor, wherein the controller, in response to receipt of the remote vehicle detection signal from the sensor, is configured to repeatedly determine a time to collision between the host vehicle and the remote vehicle, compare each determined time to collision to a threshold time, and generate a driver behavior feedback signal for use in providing an indication to the host vehicle driver of a measure of host vehicle driver behavior based on a number of times the determined time to collision exceeds the threshold time.

2. The system of claim 1 further comprising a display unit configured to receive the driver behavior feedback signal and provide the indication to the driver.

3. The system of claim 2 wherein the display unit comprises a vehicle dashboard icon, a vehicle display unit, or a remote device display unit.

4. The system of claim 1 wherein the sensor comprises a radar, lidar, ultrasonic camera, or vehicle-to-x unit.

5. The system of claim 1 wherein the controller is further configured to determine a distance between the host vehicle and the remote vehicle, to receive a signal indicative of a speed of the host vehicle, and to determine the time to collision based on the determined distance and the speed of the host vehicle.

6. The system of claim 1 wherein the threshold time comprises a configurable time.

7. The system of claim 1 wherein the measure of host driver behavior comprises a first value when the number of times the determined time to collision exceeds the threshold time exceeds a first threshold value, and wherein the measure of host driver behavior comprises a second value less than the first value when the number of times the determined time to collision exceeds the threshold time fails to exceed the first threshold value.

8. The system of claim 7 wherein the measure of host driver behavior comprises a third value less than the second value when the number of times that the determined time to collision exceeds the threshold time fails to exceed a second threshold value less than the first threshold value.

9. The system of claim 7 further comprising a memory for storing a value of the measure of the host vehicle driver behavior, and wherein the host vehicle driver earns a privilege when the measure of host vehicle driver behavior comprises the first value.

10. A method for providing driver behavior feedback to a driver of a host vehicle traveling in a lane of a roadway, the method comprising:
repeatedly determining a time to collision between the host vehicle and the remote vehicle;
comparing each determined time to collision to a threshold time; and
generating a driver behavior feedback signal for use in providing an indication to the host vehicle driver of a measure of host vehicle driver behavior based on a number of times the determined time to collision exceeds the threshold time.

11. The method of claim 10 further comprising determining a distance between the host vehicle and the remote vehicle, and wherein determining a time to collision is based on the determined distance and a speed of the host vehicle.

12. The method of claim 10 further comprising detecting a presence of a remote vehicle in front of the host vehicle in the lane of the roadway.

13. The method of claim 10 wherein the measure of host driver behavior comprises a first value when the number of times the determined time to collision exceeds the threshold time exceeds a first threshold value, and wherein the measure of host driver behavior comprises a second value less than the first value when the number of times the determined time to collision exceeds the threshold time fails to exceed the first threshold value.

14. The method of claim 13 wherein the measure of host driver behavior comprises a third value less than the second value when the number of times that the determined time to collision exceeds the threshold time fails to exceed a second threshold value less than the first threshold value.

15. The method of claim 13 further comprising storing a value of the measure of the host vehicle driver behavior in a memory, and wherein the host vehicle driver earns a privilege when the measure of host vehicle driver behavior comprises the first value.

16. A non-transitory computer readable storage medium having stored computer executable instructions for providing driver behavior feedback to a driver of a host vehicle traveling in a lane of a roadway, the host vehicle comprising a sensor for detecting a presence of a remote vehicle in front of the host vehicle in the lane of the roadway and, upon detecting the remote vehicle, generating a remote vehicle detection signal, and a controller configured to receive the remote vehicle detection signal from the sensor, the computer executable instructions configured to cause the controller to:
repeatedly determine a time to collision between the host vehicle and the detected remote vehicle;
compare each determined time to collision to a threshold time; and
generate a driver behavior feedback signal for use in providing an indication to the host vehicle driver of a measure of host vehicle driver behavior based on a number of times the determined time to collision exceeds the threshold time.

17. The non-transitory computer readable storage medium of claim 16 wherein the computer executable instructions are further configured to cause the controller to determine a distance between the host vehicle and the remote vehicle, and determine the time to collision based on the determined distance and a speed of the host vehicle.

18. The non-transitory computer readable storage medium of claim 16 wherein the measure of the host vehicle driver behavior comprises a first value when the number of times the determined time to collision exceeds the threshold time exceeds a first threshold value, and wherein the measure of the host vehicle driver behavior comprises a second value less than the first value when the number of times the determined time to collision exceeds the threshold time fails to exceed the first threshold value.

19. The non-transitory computer readable storage medium of claim 18 wherein the measure of the host vehicle driver behavior comprises a third value less than the second value when the number of times that the determined time to collision exceeds the threshold time fails to exceed a second threshold value less than the first threshold value.

20. The non-transitory computer readable storage medium of claim 18 wherein the computer executable instructions are further configured to cause the controller to store a value of the measure of the host vehicle driver behavior in a memory, and wherein the host vehicle driver earns a privilege when the measure of host vehicle driver behavior comprises the first value.
